(19) United States
(12) Patent Application Publication
(10) Pub. No.: US 2017/0369292 A1
(43) Pub. Date: Dec. 28, 2017

(54) CARGO CONTAINER LIFT TRUCK

(71) Applicants: Zhoumin Ni, New York, NY (US); Guangwei Wang, Fuzhou (CN)

(72) Inventors: Zhoumin Ni, New York, NY (US); Guangwei Wang, Fuzhou (CN)

(21) Appl. No.: 15/619,155

(22) Filed: Jun. 9, 2017

(30) Foreign Application Priority Data
Jun. 22, 2016 (CN) 201620622256.0

(51) Int. Cl. B66F 9/065; B66F 9/075; B66F 9/22; B66F 9/24

(52) U.S. Cl. CPC B66F 9/065; B66F 9/24; B66F 9/07572; B66F 9/22

(57) ABSTRACT

A cargo container lift truck includes a body having a bottom, the body including drive wheels and at least one turning whee l at the bottom, a lift nose capable of going up and down along the body, the lift nose including a lift body that goes up and down along the body, and fork levers disposed at two sides of the front of the lift body, the bottom of the fork levers having support rods to hold up a cargo container. A movement drive device drives the drive wheels, and a lift drive device drives the lift nose up and down. The body further includes a pivotable handle, the handle including buttons that control movement of the body forward and backward, and control raising and lowering of the lift nose.

### FIELD OF THE INVENTION

This disclosure relates generally to transportation equipment and, more particularly, to equipment used for moving cargo containers.

### BACKGROUND

Cargo containers are often used at factories to hold raw materials, accessories or products. The cargo containers are usually transported from place to place using a dolly. The dolly, commonly known as “tiger cart,” is a hand truck used for transporting goods in a warehouse. A dolly typically comprises a frame, the frame bottom is connected with a nose and a frame support. An axle is mounted on the frame support, and the two ends of the axle are connected to wheels. In use, the nose is inserted underneath stacked goods, then the top end of the frame is tilted downward, such that the nose moves upward and leaves the ground so that the goods are then supported by the frame. When the dolly is moved to a designated position, the top end of the frame is pushed upward, such that the nose moves downward to touch the ground, and then the goods can be unloaded. The whole process of loading, transporting and unloading cargo containers with a dolly is relatively cumbersome and inefficient.

### SUMMARY

The present disclosure describes a cargo container lift truck, which solves the above-referenced problems presented by existing dolly configurations.

One aspect of this disclosure involves a cargo container lift truck includes a body having a bottom, the body including drive wheels and at least one turning wheel at the bottom, a lift nose capable of going up and down along the body, the lift nose including a lift body that goes up and down along the body, and fork levers disposed at two sides of the front of the lift body, the bottom of the fork levers having support rods to hold up a cargo container. A movement drive device drives the drive wheels, and a lift drive device drives the lift nose up and down. The body further includes a pivotable handle, the handle including buttons that control movement of the body forward and backward, and control raising and lowering of the lift nose.

Other aspects of the disclosure involve the movement drive device comprising a drive motor, a speed reducer, at least one chain and sprockets, the drive motor is connected to, and drives, the speed reducer, the speed reducer includes at least one sprocket and each of the drive wheels include one of the sprockets, the at least one sprocket of the speed reducer is connected to at least one of the drive wheel sprockets via the at least one chain.

Still other aspects of the disclosure involve the lift drive device being a hydraulic oil cylinder.

Additional aspects of the disclosure involve the lift drive device comprising a lift motor and a lift rod driven by the lift motor.

Still further aspects of the disclosure involve a the body including a vertical support and a base, the vertical support is fixed onto the base, and the base includes a U-shaped support groove.

Yet other aspects of the disclosure involve the at least one turning wheel being a single turning wheel and the driving wheels and single turning wheel being positioned in a triangle configuration.

Further aspects of the disclosure involve the turning wheels comprising universal casters.

Additional aspects of the disclosure involve the at least one turning wheel being two turning wheels, and the drive wheels and the turning wheels being positioned in a quadrilateral configuration.

Finally, some aspects of the disclosure involve the handle including a speed regulation button.

The foregoing and following outlines rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWINGS

This disclosure is further described in the detailed description that follows, with reference to the drawings, in which:

FIG. 1 illustrates, in simplified form, a schematic view of one example cargo container lift truck as described herein; and

FIG. 2 illustrates, in simplified form, a schematic view of the cargo container lift truck of FIG. 1 from a different direction.

### DETAILED DESCRIPTION

Specific examples of our cargo container lift truck will now be described with reference to the accompanying drawings. It should be apparent that the described examples are only representative of a few, not all, of the embodiments that can be created based upon this disclosure. All other embodiments that can be created by those skilled in the art based on the examples herein are intended to be encompassed by the present disclosure.

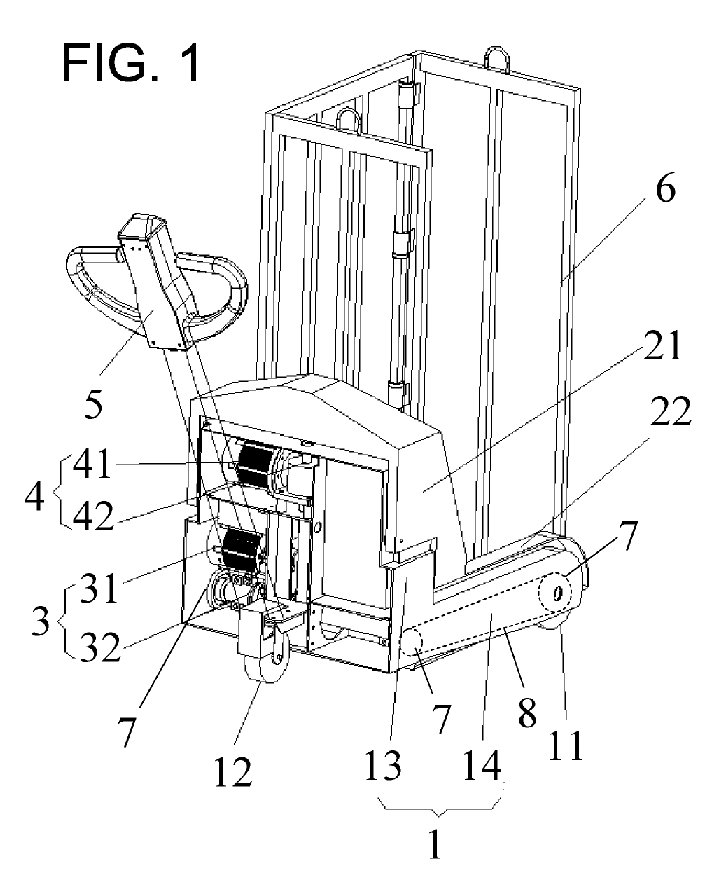

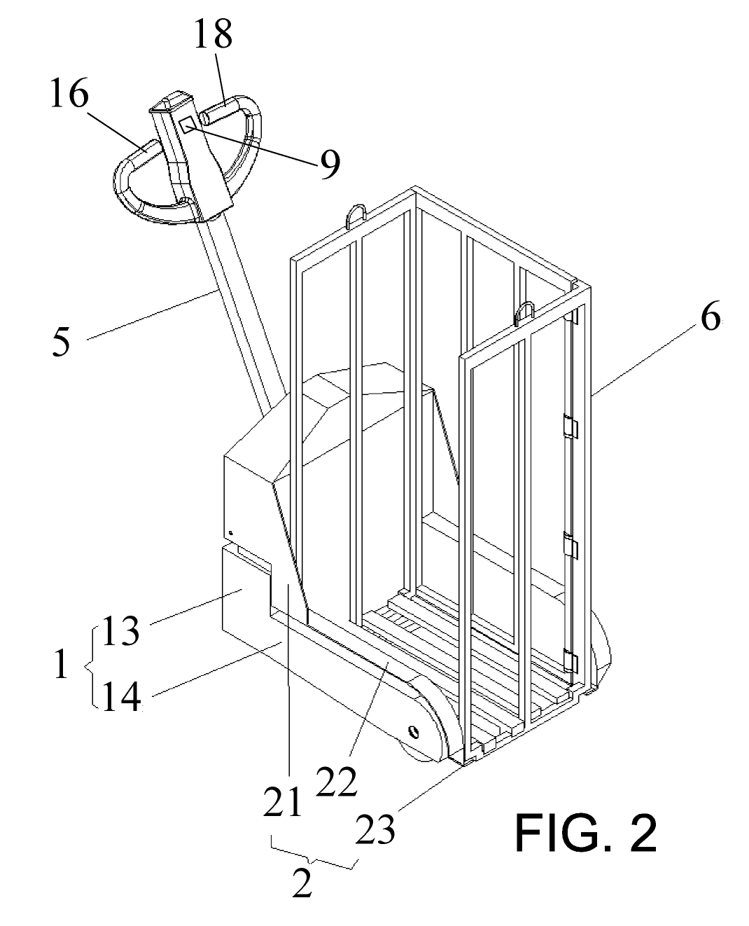

Referring to FIG. 1 and FIG. 2, the cargo container lift truck comprises a body 1. The body 1 includes drive wheels 11 and at least one turning wheel 12 at the bottom. The body 1 also includes a lift nose 2 that capable of going up and down along the body 1. More specifically, the lift nose 2 comprises a lift body 21 that goes up and down along the body and fork levers 22 located on the two sides of the front of the lift body 21. The bottom of the fork levers 22 includes support rods 23 for holding up a cargo container 6. The body 1 further includes a movement drive device 3 that rotationally drives the drive wheels 11 and a lift drive device 4 that drives the lift nose 2 up and down. The body 1 further includes a pivotable handle 5 to control the body. The handle 5 includes buttons 16, 18, one 16 that controls forward and backward movement of the body and another 18 that controls raising and lowering of the lift nose. During use, the lift nose 2 is initially in its lowest position so that it can go underneath a cargo container 6. Then the lift nose 2 is raised and the lift truck and cargo container 6 are moved to a new location. The lift nose 2 is then lowered at the new location, yielding a use that is simple, convenient, and efficient.

The movement drive device 3 comprises a drive motor 31, a speed reducer 32, sprockets 7 and chains 8. The drive motor 31 is connected to, and drives, the speed reducer 32. The speed reducer 32 and the drive wheels 11 each include the sprockets 7, and the sprockets are connected to each other via the chains 8 so that the drive wheels 11 can be driven.

Ideally, the lift drive device 4 is a hydraulic oil cylinder, which directly controls the raising and lowering of the lift nose. Alternatively, the lift drive device 4 is a lift motor 41 and a lift rod 42 that is driven by the lift motor 41. The lift motor 41 controls the raising and lowering of the lift rod 42 to control raising and lowering of the lift nose 2.

In addition, the body 1 comprises a vertical support 13 and a base 14, the support 13 is fixed onto, or part of, the base 14, and the base 14 is provided with a U-shaped support groove.

Ideally, there are two drive wheels 11 and one or two turning wheels 12, with the drive wheels 11 and the turning wheels 12 being positioned in a triangle configuration (if only one turning wheel 12) or a quadrilateral configurations (e.g., square) (if two turning wheels 12).

Ideally, the turning wheels 12 are universal casters.

The handle 5 also includes a speed regulation button 9. The speed regulation button is used to regulate the speed at which the body 1 moves forward and backward.

Having described and illustrated the principles of this application by reference to one or more example embodiments, it should be apparent that the embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A cargo container lift truck comprising:
a body having a bottom, the body including
drive wheels and at least one turning wheel at the bottom;
a lift nose capable of going up and down along the body, the lift nose including
lift body that goes up and down along the body, and
fork levers disposed at two sides of the front of the lift body;
the bottom of the fork levers having support rods to hold up a cargo container;
a movement drive device that drives the drive wheels; and
a lift drive device that drives the lift nose up and down;
the body further comprising a pivotable handle, the handle including buttons that control movement of the body forward and backward, and control raising and lowering of the lift nose.

2. The cargo container lift truck of claim 1, wherein:
the movement drive device comprises a drive motor, a speed reducer, at least one chain and sprockets, the drive motor is connected to, and drives, the speed reducer, the speed reducer includes at least one sprocket and each of the drive wheels include one of the sprockets, the at least one sprocket of the speed reducer is connected to at least one of the drive wheel sprockets via the at least one chain.

3. The cargo container lift truck of claim 1, wherein the lift drive device is a hydraulic oil cylinder.

4. The cargo container lift truck of claim 1, wherein the lift drive device comprises a lift motor and a lift rod driven by the lift motor.

5. The cargo container lift truck of claim 1, wherein:
the body comprises a vertical support and a base, the vertical support is fixed onto the base, and the base includes a U-shaped support groove.

6. The cargo container lift truck of claim 1, wherein the at least one turning wheel is a single turning wheel and the driving wheels and single turning wheel are positioned in a triangle configuration.

7. The cargo container lift truck of claim 6, wherein the turning wheels comprise universal casters.

8. The cargo container lift truck of claim 1, wherein the at least one turning wheel is two turning wheels, and the drive wheels and the turning wheels are positioned in a quadrilateral configuration.

9. The cargo container lift truck of claim 1, wherein the handle includes a speed regulation button.
